(19) United States
(12) Patent Application Publication
(10) Pub. No.: US 2016/0200248 A1
(43) Pub. Date: Jul. 14, 2016

(54) BLUETOOTH LOW ENERGY (BTLE) SMART CAR SEAT ALERT SYSTEM

(71) Applicants: Rajinder Singh, San Jose, CA (US); Ihab Abu-Hakima, Los Altos, CA (US); Gurpreet Singh Bal, Brampton (CA)

(72) Inventors: Rajinder Singh, San Jose, CA (US); Ihab Abu-Hakima, Los Altos, CA (US); Gurpreet Singh Bal, Brampton (CA)

(21) Appl. No.: 14/883,604

(22) Filed: Oct. 14, 2015

Related U.S. Application Data
(60) Provisional application No. 62/063,924, filed on Oct. 14, 2014.

(51) Int. Cl. B60Q 9/00; G08B 21/02; B60N 2/28

(52) U.S. Cl. CPC B60Q 9/00; B60N 2/28; G08B 21/0277

(57) ABSTRACT

A smart car system maintains a Bluetooth paired heartbeat between a modified car seat and a smart phone. The system automatically alerts a responsible person when children are unsafely left inside of vehicles, as detected by a loss of the Bluetooth paired heartbeat.

### CROSS-REFERENCE TO RELATED PATENT APPLICATIONS

This application claims the benefit of U.S. Provisional Application No. 62/063,924, filed on Oct. 14, 2014, by Rajinder SINGH, the content of which is hereby incorporated by reference in its entirety.

### FIELD OF THE INVENTION

The invention relates generally to a networked car set, and more specifically, to a car set to send notification of a child left in a vehicle.

### BACKGROUND

Car seats are attached to standard vehicle seats for transporting infants, toddlers and small children. The modified form factor provides a safer mode of transport and is required by law for some passengers. Unfortunately, car seats are typically in the rear of a vehicle, and as a result, children are often unsafely left in the car seats. Heat and other factors can threaten the health and even the life of children in this circumstance.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a block diagram illustrating a smart car system 100, according to an embodiment.

### DESCRIPTION

### Overview of Features

To address the problems of the prior art, devices, methods, and computer-readable medium to send notifications when a child is left in a vehicle are disclosed. For example, smart car system maintains a Bluetooth paired heartbeat between a modified car seat and a smart phone to automatically alert a responsible person when children are unsafely left inside of vehicles, as detected by a loss of the Bluetooth paired heartbeat. One of ordinary skill in the art will recognize many other possible implementations which and are not limited by the details provided below. For example, the same principles can be applied to a sensor and alert systems for pets, special need adults, precious objects, or any other desirables inadvertently left inside of vehicles.

### System for Smart Car Seat Alerts

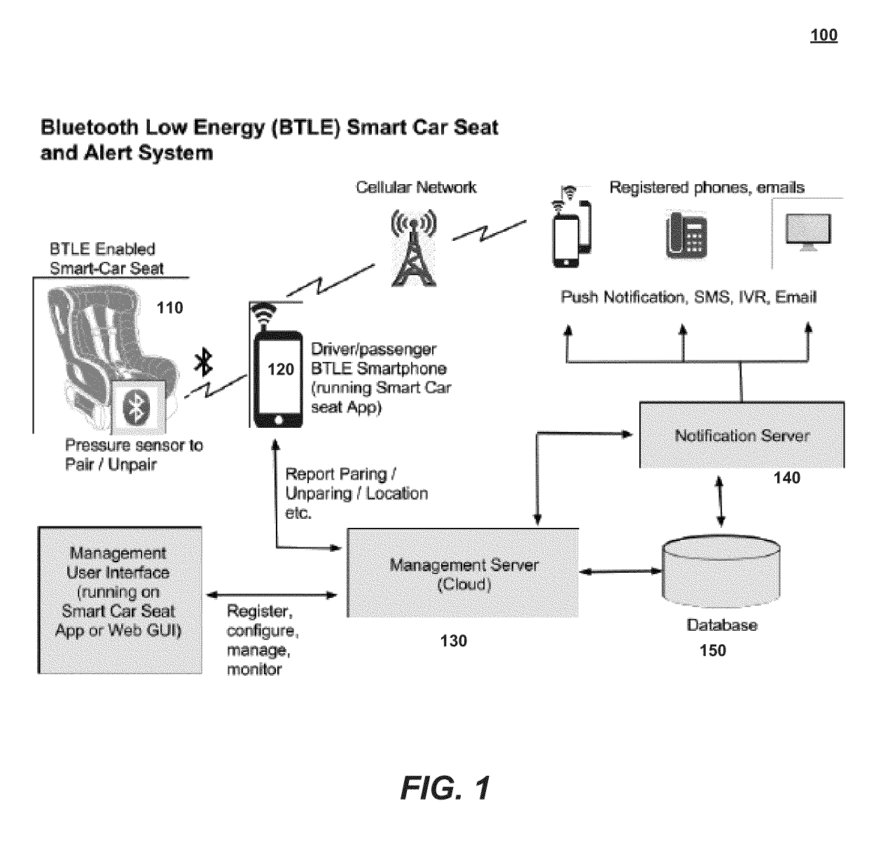

FIG. 1 is a block diagram illustrating a smart car system 100, according to an embodiment. The system 100 includes a car seat 110, a wireless host 120, a management server 130, a notification server 140 and a database 150. Each of the components can be coupled in communication through a data network. The data network can be a single network or a combination of hybrid networks (e.g., the Internet, a LAN, a 3G or 4G, a Wi-Fi, Ethernet, or Bluetooth network).

The car seat 110 can be a standard car seat that is modified with a communication module, or be a smart car seat having an integrated communication module embedded during manufacture. The car seat 110 can be used to hold or boost an infant, toddler or small child in a seat having a smaller form factor cavity providing for a safer transport for these individuals while riding in an automobile. In other embodiments, the car set 110 can be a pet cage, a full size car seat, or the like.

The communication module can comprise a pressure sensor coupled to a processor, a transceiver and a power source. The pressure sensor detects when an individual is present in the car seat 110 based on a minimum weight of, for example, 10 pounds being detected. The processor analyzes data form the pressure sensor and the transceiver. The transceiver, in one embodiment, is a Bluetooth low energy transceiver with an RF radio for transmitting and receiving data. The power source can be a rechargeable battery, a solar-powered battery, or a connection to an automobile battery. In other embodiments, sensors such as a motion detector or temperature sensor can be used alone or in combination with the pressure sensor, depending upon the application.

The wireless host 120 can be a smart phone, a phablet, a tablet device, a lap top, or any other mobile processor-driven device. A mobile application can be downloaded to communication with cloud-based resources, and also to configure heartbeats. A first heartbeat can be maintained between the wireless host 120 and the car seat 110. An optional second heartbeat can be maintained between the wireless host 120 and cloud-based services, such as the management server 130.

The management server 130 is part of a cloud-based service that manages back end processes. The notification server 140 is triggered by the management server 130 when a heartbeat is broken to send out alerts as configured by, for example, e-mail, SMS, or the like. The database 150 can store user profiles along with configurations for alerts, payment information, authentication, and the like.

### Registration

A user can install an application on a smartphone. The user also installs a retrofitted BTLE device on a car seat, unless integrated during manufacture. A user pairs the BTLE device and smartphone or otherwise initializes a communication channel between components. A user can then register with a service that manages the alerts by providing, for example, pairing details, telephone numbers for sending alerts, email addresses for sending alerts, emergency service configurations, and notification events.

### Scenarios

In a first scenario, no child (or pet, or special needs adult, etc.) is in the seat. Because a pressure sensor does not activate a transceiver, the system remains off or in a low power mode.

In a second scenario, a child is in the car seat.

This time, a pressure sensor does activate a transceiver for pairing with a wireless host. The pairing can be automated or can require manual confirmation. Periodically, a heartbeat message is sent between the car seat and the wireless host to verify that the two remain within proximity. Heartbeats can be sent from either device. In one implementation, proximity is defined by the limits of Bluetooth connectivity. In other implementations, locations of both components are determined and a distance is determined with respect to an allowable threshold.

In a third scenario, a child is safely removed from the car seat. Once the child is removed, the pressure sensor deactivates the transceiver or merely unpairs from the wireless device. A heartbeat is no longer required at this point. The system can turn off, or remain in a low power mode for a certain period of time.

In a fourth scenario, a child is unsafely left in the car. A heartbeat is no longer detected because the wireless device is no longer in proximity with the car seat. In response, the wireless device notifies the management server of the event. In turn, the database records are searched for appropriate notification procedures by the notification server. For example, a beep or SMS message at a smartphone can alert a parent of the mistake.

In a fifth scenario, a smartphone loses power. The child may or may not be in the child seat. In one embodiment, the management server initiates an alert because no heartbeat has been sent from the wireless device. In this case, an e-mail can be sent or an alternative telephone number can be used to send the alert. In another embodiment, the car seat can also recognize the missing heartbeat and connect to a Bluetooth system in the vehicle as an alternative mechanism for alerts. In still another embodiment, the car seat uses Wi-Fi or a cellular data network as an alternative form of communication.

In a sixth scenario, both a child and the wireless device are inadvertently left behind in a vehicle. Process can be similar to the fifth scenario once the wireless device exhausts power. The system can also generate alert if the pairing has exceeded a configured time limit (e.g., pairing time exceeds one hour). The system can generate an informative alert, or a caution that is not as pronounced. During long drives when child and parents are all in the car, this alert may not require any action.

We claim:

1. A Bluetooth low energy car set alert system to detect when children are inadvertently left in:
a car seat sensor affixed to a car seat that secures children in an adult vehicle to detect when a child is in the car seat and when a child is not in the car seat;
a Bluetooth low energy radio affixed to the car seat and paired to a second Bluetooth enabled device to maintain a heartbeat between the radio and device over a Bluetooth channel; and
an alert system to detect when the heartbeat has been disrupted in combination with a child being in the car seat and, in response, to send an alert notification to at least the device.
